(19) United States
(12) Patent Application Publication
(10) Pub. No.: US 2026/0335903 A1
(43) Pub. Date: Oct. 29, 2026

(54) PLANT AND METHOD FOR RECYCLING CONTAINERS AND/OR PACKAGING COMPONENTS MADE OF PLASTIC

(71) Applicant: Krones Recycling GmbH, Flensburg (DE)

(72) Inventor: Vassil Raego, Langenhorn (DE)

(21) Appl. No.: 19/649,066

(22) Filed: Apr. 15, 2026

(30) Foreign Application Priority Data
Apr. 24, 2025 (DE) 10 2025 115 767.7

(51) Int. Cl. B02C 23/36

(52) U.S. Cl. CPC B02C 23/36

(57) ABSTRACT

A plant system and a method for recycling containers and/or packaging components, in each case made of plastic, are described. The plant system comprises at least one cutting mill for wet-shredding the containers into flakes and a washer for wet cleaning the flakes that follows in terms of the recycling process. The washer comprises at least one trough for receiving the flakes, at least one conveying means for mixing the flakes and for transporting the flakes through the trough, and dispensing apparatuses arranged above the at least one conveying means for dispensing a washing liquid onto the flakes as the flakes are being mixed. This makes possible a particularly gentle washing and thus makes possible an efficient recycling of containers and packaging components, even those with comparatively thin and brittle walls.

### CROSS-REFERENCE TO RELATED APPLICATION AND PRIORITY CLAIM

This application claims priority to German Patent Application No. 10 2025 115 767.7, filed Apr. 24, 2025, the disclosure of which is incorporated herein by reference in its entirety.

### TECHNICAL FIELD

The invention relates to a plant and to a method for recycling containers and/or packaging components made of plastic.

### BACKGROUND

It is well known that plastic containers and/or packaging components can be processed after use, for example for the filling and sale of beverages or similar food products, by shredding and washing for a reuse of the plastic. The plants used for this purpose correspondingly comprise at least one shredding module with a wet mill and a friction washer, and a downstream washing module for providing the pre-wash and main wash for the shredded plastic.

### SUMMARY

The wet mill shreds the material into so-called flakes of a suitable size, for example corresponding to a predetermined screen perforation. The water used in the wet mill dissolves impurities and in the process circulates through particle screens and is treated, if necessary, by flotation and/or decantation. The friction washer, which usually follows directly, serves to separate fine particles and dirt from the flakes, essentially by centrifugation, and makes it possible for said flakes to be pre-dried. Here, rotating paddles move the material relatively rapidly in an approximately radial direction against a screen basket. The flakes bounce back and forth, thus allowing water and fine particles to escape through the screen basket.

The flakes are then usually temporarily stored downstream to ensure a uniform mass flow. They can be stored wet, but additional drying steps and a zigzag separator can also be used for intermediate storage in silos and/or for label removal.

The washing module comprises a pre-washer on the inlet side for the mechanical cleaning of the flakes by softening and washing away relatively coarse dirt in the continuous water circuit. The flakes are preheated and mixed by a horizontal shaft comprising plowshare and disk tools, then conveyed over a weir-type barrier to the outlet. The relatively slow rotation of the shaft, combined with the axial conveying motion, creates friction that releases labels, adhesive, and other contaminants. The pre-washer can be designed with multiple stages to optimize the washing quality of the flakes through separate circuits for water of varying degrees of dirtiness.

Floating and sinking fractions can then be separated from each other.

The washing module also always comprises a hot-wash stage for intensive washing in order to chemically remove contaminants such as adhesives, dirt, grease, proteins and the like, usually by using diluted sodium hydroxide solution with detergent and defoamer. The washing module is also typically used for subsequent rinsing and classification of the flakes by means of a float-sink method, for drying them in rotary and convection dryers, and for the final classification of the washed and dried material in a zigzag separator, wherein lightweight components such as labels, dust, or films are removed from the heavier flakes.

A disadvantage of plants with the above process division into the wet-shredding module and washing module is firstly the large number of process units required for material separation, washing and drying as well as the associated water circuits and secondly the relatively low material yield or even lack of suitability for thin-walled and/or brittle containers and packaging components, as these are shredded excessively and ultimately result in material loss.

There is therefore a need for improvement in this regard.

The stated object is achieved by the subject-matter of this disclosure. Advantageous embodiments are, among other things, also specified in this disclosure.

The plant described is used for recycling starting material in the form of used containers and/or packaging components, the wall structure of each of which consists substantially, e.g. at least 90%, of plastic. The recycling here consists of a shredding of the containers or packaging components and a subsequent cleaning of the shredded material.

For this purpose, the plant comprises at least one cutting mill for the wet-shredding of the containers/packaging components into flakes and a washer for wet-cleaning the flakes that follows with regard to recycling. The washer comprises at least one trough for receiving the flakes, at least one conveying means for mixing the flakes and for transporting them through the trough, and dispensing apparatuses arranged above the conveying means for dispensing a washing liquid onto the flakes as they are being mixed.

Surprisingly, it has been found that contamination resulting from wet-shredding and/or from contamination of the starting material, such as particles of foreign matter and soluble components, can be removed from the flakes in a manner that is particularly material-friendly yet sufficiently effective by simultaneously mixing the flakes and supplying water thereto.

This allows containers and packaging components with particularly thin and brittle wall sections to be ground into flakes and washed in such a way that the flakes are not excessively shredded and therefore do not result in material loss during subsequent washing and separation processes and thus undesirably reduce the overall efficiency of the recycling method.

The containers are or comprise, for example, beverage bottles with a wall thickness of 200 µm to 3 mm and the packaging components are or comprise trays with a wall thickness of 100 to 500 µm, in particular those made of PET.

The containers can also be beakers, for example for holding dairy products, or other food containers. Other possible container materials include PS, PP, PE and other plastics. Corresponding wall thicknesses then range, for example, from 200 µm to 1 mm.

A washer (or such a process control device) that follows the wet-shredding process with regard to the recycling process is understood to mean that the flakes do not pass through any further process units therebetween for cleaning and in particular washing, such as a friction washer. This makes an improved material yield possible as well as reduced equipment requirements.

The described washer and the cutting mill can therefore be designed as a plant module with common media supply and/or control, for example by automatically supplying the cutting mill with wastewater from the washer. In other words, the washer or a pre-wash of the flakes can be integrated into a wet-milling module. A pre-wash in a downstream washing module for hot/intensive washing is accordingly unnecessary. This allows a reduction in installation and operating costs of the plant compared to the previously customary distribution of the process among the wet-milling module and washing module.

The cutting mill can be a process unit having a design that is known in principle, for example as described at the outset, so this will not be discussed in further detail. Advantageously, the described plant can comprise two parallel cutting mills which the washer directly follows in the process in the above sense.

It is advantageous if the washer comprises at least two consecutive washing stages, comprising recirculation circuits for the washing liquid used in each washing stage. The recirculation circuits are preferably connected by means of cascading lines such that the washing stages can supply one another with the washing liquid counter to the material flow of the flakes. The washing stages are then as regards the flow of washing liquid cascaded in the opposite direction to the flow of flakes. This means that the first cascading stage is located in the region of the last washing stage, and the last cascading stage is located in the region of the first washing stage.

In the region of the last washing stage, process water and/or fresh water generated or treated outside the described plant can be supplied to the washer so that the best water quality is present there in relation to the washer as a whole, and the flakes can be rinsed off with correspondingly clean water in the first cascading stage immediately before being discharged from the washer. For this purpose, for example 0.5 to 2 l/kg of liquid replenishment is dispensed to the washer via the first cascading stage. This also allows contaminants with a dirt load increasing in the opposite direction to the material flow of the flakes to be removed particularly effectively by means of the washing liquid.

The washing liquid is essentially water, which may, as a result of liquid carryover from a subsequent hot wash, contain, for example, low concentrations of lye and added additives such as detergents and defoamers. The washing liquid can accordingly be process water originating, at least in part, from a washing module or a hot wash for the flakes and have a temperature of, for example, 30° to 50° Celsius. The process water can, for example, flow from a post-washer via at least one density separator, which may be connected in series, into the described washer from where it replenishes the water circuit of the at least one cutting mill.

The throughput of the washing liquid in individual washing stages can be, for example, 50 to 150 m³/h and/or 10 to 50 l/kg of flakes. These values are suitable, for example, for a material throughput of the flakes of 2000 to 4000 kg/h (for example, assuming a bulk density of 250 kg/m³ ± 20%).

The described plant and the described method are suitable for recycling various plastics commonly used in food technology, such as PET, PP, PE and/or PS.

Particularly gentle washing of the flakes is made possible if the transport means is designed as a lying, in particular horizontal, shaft with conveying means that rotate thereon and the shaft rotates at a comparatively low rotational speed of 5 to 30 revolutions per minute during operation. For example, for a rotational speed of 17 revolutions per minute and a radius of the associated trough of 400 mm, a maximum peripheral speed of 0.7 m/s results at the wall of the trough, which causes only relatively gentle friction among the flakes so that even relatively thin-walled and brittle flakes are not subjected to further shredding. The radius of the trough can be, for example, 200 to 800 mm.

Preferably, the plant comprises a supply line for supplying the at least one cutting mill with washing liquid collected in the washer. The supply line can optionally branch off from a storage tank, which is integrated into a recirculation circuit of the inlet-side washing stage and is fed with the washing liquid via at least one processing stage for solid-liquid separation, in particular a hydrocyclone and/or a screening machine. For example, for this purpose a line can return to the collection container or tank of the first washing stage in the sense of a mechanical overflow, in order to set a suitable water quality in the first washing stage.

The described combination of cutting mill(s) and downstream washer can be understood as a wet-milling module with integrated pre-washing. This can be followed by intermediate storage of the flakes, which can be stored both wet as well as dry in a silo (as a result of an additional drying step). Furthermore, a washing module for hot/intensive washing of the flakes can follow, which then manages without (additional) pre-washing of the flakes. The plant described then comprises in total at least one cutting mill, a washer immediately following said mill and the downstream washing module.

The subsequent washing module preferably comprises: a hot-washing stage for intensive washing to remove adhesives, dirt, grease, proteins and similar contaminants, for example by using diluted sodium hydroxide solution with detergent and defoamer; following this, treatment stages for rinsing and classifying the flakes by means of a sink-float process; at least one rotary and/or convection dryer for drying the flakes; and a separator for classifying the material washed and dried in this way.

The power requirement of the washer itself can be 10-30 kW and for additional drives to supply the cutting mill 8-35 kW and/or the specific electricity consumption of the washer itself can be 0.003-0.015 kWh per kg of starting material and for additional drives to supply the cutting mill 0.008-0.025 kWh per kg of starting material. This includes, for example, pump and screening machine drives, but not the drive for the at least one cutting mill itself.

The electrical power converted for the recycling process by the entire plant, including the at least one cutting mill and a downstream washing module, can then be, for example, 300 to 400 kW and/or the specific energy can be 0.1 to 0.15 kWh per kg of starting material. The heating output can accordingly be, for example, 315 to 465 kW and/or the heat requirement can be 0.11 to 0.16 kWh per kg of starting material.

It goes without saying that corresponding process steps can be carried out using the described apparatus features, modules or the like, and that the plant can be designed accordingly to carry out the described method steps.

### BRIEF DESCRIPTION OF THE DRAWINGS

The accompanying drawings show, by way of example, aspects and/or exemplary embodiments of the invention for better understanding and illustration. In the drawings:

FIG. 1 illustrates a schematic representation of a plant with material flows.

### DETAILED DESCRIPTION

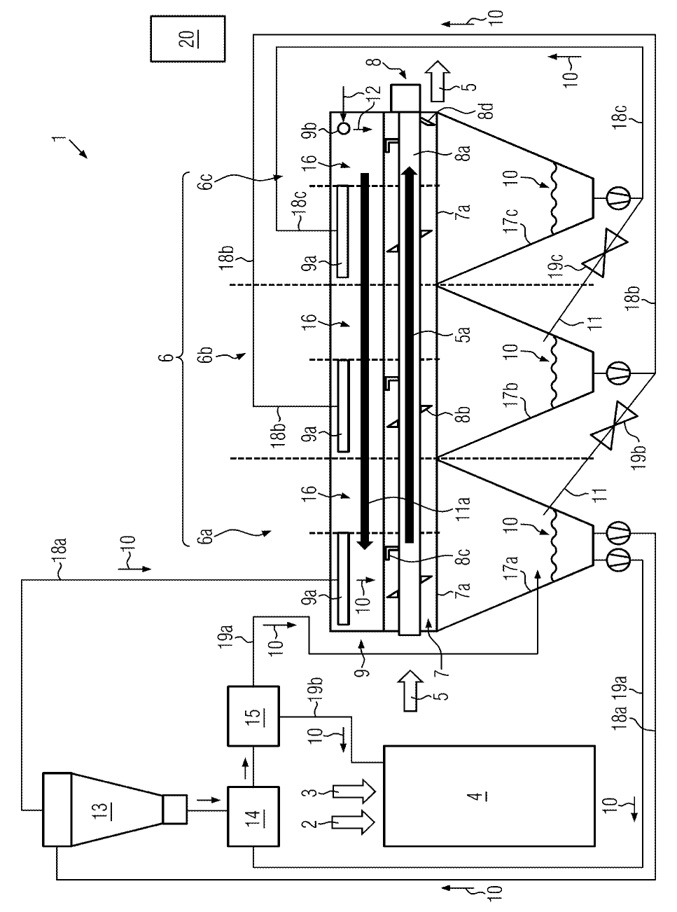

FIG. 1 illustrates a schematic representation of a plant 1 with material flows. As can be seen from the figure, the plant 1 for recycling starting material in the form of used containers 2 and/or packaging components 3 made of plastic comprises at least one cutting mill 4 for wet-shredding of the containers 2 and/or packaging components 3 into flakes 5 and a washer 6 for wet-cleaning the flakes 5, which directly follows said mill in terms of the processing technology.

The washer 6 comprises: a trough 7 for receiving the flakes 5 during washing; a conveying means 8 for mixing the flakes 5 and for transporting them from the material inlet to the material outlet of the trough 7; and dispensing apparatuses 9 arranged above the conveying means 8 for dispensing a washing liquid 10 onto the flakes 5 while they are being mixed in the trough 7. The average time spent by the flakes in the trough 7 is, for example, 5 to 15 minutes.

The washer 6 can comprise at least two parallel treatment lanes (not shown) that each comprise a trough 7, conveying means 8 and associated dispensing apparatuses 9.

The washing liquid 10 consists essentially of water with the optional addition and/or carryover of lye, detergent, defoamer and/or similar additives.

In the example, the washer 6 comprises three consecutive washing stages: a first washing stage 6a on the input side with respect to the direction of transport 5a of the flakes 5 (and thus the direction of the material flow), a second washing stage 6b that follows it, and a third or final washing stage 6c on the output side.

The third washing stage 6c can have a higher throughput of washing liquid 10 and/or a longer dwell time of the flakes 5 than each of the first and second washing stages 6a, 6b, and for this purpose may be of greater length in the direction of transport 5 (not shown), for example. In principle, individual washing stages 6a, 6b, 6c can be individually designed in this respect and differ from one another accordingly.

The washing liquid 10 is collected separately in the individual washing stages 6a, 6b, 6c under the trough 7 where it circulates back to the corresponding dispensing apparatus 9. In addition, at least two of the washing stages 6a, 6b, 6c are connected to one another by a cascading line 11 in order to partially supply one another with washing liquid 10 counter to the material flow of the flakes 5, wherein the flow direction 11a of the overall resulting washing liquid cascade is counter to the direction of transport 5a of the flakes 5.

The third or final washing stage 6c forms a first cascade stage here, to which external process water 12 and/or fresh water is supplied. The washing liquid 10 is thus continuously replenished by the process water 12 and/or fresh water. Accordingly, the supplied process water 12 and/or fresh water is of a better quality than the washing liquid 10 circulating in the washer 6. The inlet-side first washing stage 6a and the middle second washing stage 6b are then partially supplied with washing liquid 10, which is collected in the washing stage 6b, 6c that follows downstream (in the direction of transport 5a) in each case. Accordingly, the dirt load of the washing liquid 10 increases from the outlet-side third washing stage 6c to the inlet-side first washing stage 6a, which thus forms the last cascade stage.

The drawing also schematically shows that the washing liquid 10 collected in the first washing stage 6a on the inlet side can be used to supply water to the cutting mill 4. This enables a particularly efficient water supply for the cutting mill 4 and the washer 6 in the sense of a jointly formed wet-milling module. This is also possible for two cutting mills 4 operating in parallel or when at least one cutting mill 4 is in standby mode.

For this purpose, washing liquid 10 collected in the first washing stage 6a can first be fed to a hydrocyclone 13. A portion, namely the clarified overflow, of the washing liquid 10 cleaned therein can be returned to the first washing stage 6a to be dispensed onto the flakes 5. A second portion, namely the thickened underflow, of the washing liquid 10 supplied to the hydrocyclone 13 can be fed via a screening machine 14 and/or another processing stage for solid-liquid separation (for the purpose of removing the contamination from the process) to a storage tank 15, which serves as a reservoir for the water supply to the cutting mill 4 and/or to the first washing stage 6a. Additionally or alternatively, a mechanical overflow for any excess quantity from the storage tank 15 is possible.

It goes without saying that suitable pumps are available for conveying the washing liquid 10, which pumps may be omitted from the illustration for the sake of simplicity.

As the drawing further schematically shows, the transport means 8 comprises a motor-driven shaft 8a, which is lying and preferably horizontal and extends across all of the washing zones 6a, 6b, 6c. Conveying tools 8b, 8c, 8d are arranged on the shaft 8a that rotate together therewith.

For example, the conveying tools 8a are structures similar to a plowshare, which, among other things, ensure that the flakes 5 move in the direction of transport 5a, i.e. essentially axially with respect to the shaft 8a. This results on average in a helical transport path of the flakes 5 during their simultaneous separation and mixing.

The conveying tools 8b are, for example, so-called disk tools, which likewise separate and mix the flakes 5 and clean a screen surface 7a formed on the trough 7 by guiding the flakes 5 along the screen surface 7a and thus making possible a self-cleaning effect of the trough 7 during operation.

The conveying tool 8d is, for example, a carrier arranged at the output end (in the direction of transport 5a) of the shaft 8a, which ensures that the flakes 5 are discharged from the washer 6.

The trough 7 is designed, at least in its lower region, as a screen basket, the screen surface 7a of which, for example, has a hole width of 2 mm. In contrast, in the region of the first washing stage 6a, the hole width can also be increased and, for example, be 3 mm. Such screen surfaces 7a are suitable for retaining the flakes 5, whereas the washing liquid 10 dispensed in each of the washing zones 6a, 6b, 6c is able to flow out of the trough 7 after contact with the flakes 5.

The drawing schematically indicates that the dispensing apparatuses 9 can be designed as overflows 9a with baffles, from which the washing liquid 10 runs down onto the flakes 5 in a manner that is known in principle.

Furthermore, each overflow 9a can be followed by a draining zone 16 in which the flakes 5 can be left to drain before entering the next washing zone 6b, 6c each time or before the final rinse, in order to increase the efficiency of the washing process.

The dispensing apparatuses 9 can include at least one spray tube 9b or the like extending transversely to the direction of transport 5 at the outlet of the last washing stage 6c, from where the flakes 5 are rinsed off using process water 12 of a suitable quality or using fresh water immediately before being discharged from the washer 6. The spray tube 9b then forms the first cascade stage. In other words, the best water quality available in the washer 6 is used immediately before the material outlet of the washer 6 for rinsing the flakes 5 for the final time.

Each of the washing stages 6a, 6b, 6c comprises, in the region below the at least one trough 7, a collection container 17a, 17b, 17c for collecting the washing liquid 10 dispensed in each washing stage 6a, 6b, 6c. The collection containers 17a, 17b, 17c open into recirculation circuits 18a, 18b, 18c, in which the washing liquid 10 circulates within each washing stage 6a, 6b, 6c.

The cascading lines 11 can branch off from the recirculation circuits 18b and 18c of the second and third washing stages 6b, 6c and then open into the collection container 17a, 17b of each washing stage 6a, 6b that is upstream with respect to the material flow, for example via machine-controlled actuators 19b, 19c of a type that is known in principle.

The collection container 17a of the first washing stage 6a can, as shown by way of example, be assigned two separate recirculation circuits 18a, 19a (with 15a) in order to supply washing liquid 10 via the hydrocyclone 13 and/or the screening machine 14 not only to the cutting mill 4 but also to return it to the first washing stage 6a.

For example, the recirculation circuit (the line) 19a can only return to the collection container (tank) 17a as a mechanical overflow, since the recirculation circuit 18a usually has a better quality of water to be supplied to the flakes 5 than after the screening machine 14. The water supply 19b of the cutting mill 4 can be supplied by, for example, one pump per cutting mill 4. An overflow can also serve to prevent the storage tank 15 from being sucked dry in this case.

In principle, other/further recycling processes are also conceivable in at least one of the collection containers 17a, 17b, 17c, for example in the case of relatively heavy contamination of the flakes 5. Alternatively or additionally, this could be removed from the washing process by means of, for example, drum screens, flotation and/or similar recycling stages for solid-liquid separation.

The hydrocyclone 13 is used for the separation of sinking substances, such as sand with a particle size above 50 µm. The underflow of the hydrocyclone 13 preferably flows (possibly assisted by a pump) onto a screening machine 14, in which these solids are separated from the washing liquid 10. The screening machine 14 can remove impurities separated in this way from the washing liquid 10 and thus from the washing process or from the plant 1. The overflow of the hydrocyclone 13 generally has a better water quality than the washing liquid 10 circulating in the first washing stage 6a and can therefore be advantageously dispensed onto the flakes 5 present in the first washing zone 6a.

After cleaning in the screening machine 14, the underflow of the hydrocyclone 13 can be passed as washing liquid 10 into the storage tank 15. This optionally serves to supply the cutting mill 4 or, if necessary, at least two cutting mills 4, with washing liquid 10 via a supply line 19b. Excess washing liquid 10 can be directed from the storage tank 15 back into the first washing stage 6a.

The washer 6 can have two parallel troughs 7, each with conveying means 8 (not shown), which extend equally through all the existing washing zones 6a, 6b, 6c. The shafts 8a of the conveying means 8 could then rotate (in pairs) in opposite directions. The plant 1 can comprise at least two cutting mills 4 (not shown), each of which is then preferably assigned one of the parallel troughs 7. For these, only one common water supply involving recirculation and cascading of the washing liquid 10 is, however, required per washing stage 6a, 6b, 6c, so that the at least one cutting mill 4 and the washer 6, possibly in a multi-lane design, can also be combined particularly efficiently and flexibly in one plant module with regard to the water supply.

In addition, the total number of process units required for the necessary cleaning effect is minimized, making possible a particularly gentle cleaning even of relatively thin and brittle flakes 5 and thus a recycling that saves on resources, such as electricity, operating materials and/or maintenance, and provides a particularly high material yield. The described plant/method can be followed by process units or processes that are known in principle for intermediate storage, hot/intensive washing, drying and classification of the flakes, whereby additional pre-washing is no longer required for the hot/intensive washing.

In the product stream of the flakes 5, the plant 1 comprises a washing module 20 downstream of the washer 6, which may comprise, in a manner known in principle, a hot-washing stage for intensive washing, for example using diluted sodium hydroxide solution with detergent and defoamer, a subsequent treatment stage for rinsing and classifying the flakes using a float-sink method, a rotary and/or convection dryer for drying the flakes, and, for example, a zigzag separator for classifying the washed and dried flakes 5.

With the described method, a material yield of 97 to 99.5% of the flakes 5 after being washed in the trough 7 can be achieved in relation to the amount of material from the containers 2 and/or packaging components 3 that is fed to the cutting mill 4. After the washing module 20, the corresponding yield can be between 70 and 95%.

What is claimed is:

1. A plant system for recycling containers and packaging components, each made of plastic, comprising:
at least one cutting mill for wet-shredding the containers into flakes; and
a washer that follows with regard to a recycling process for wet cleaning the flakes, wherein the washer comprises:
at least one trough for receiving the flakes;
at least one conveying means for mixing the flakes and for transporting the flakes through the trough; and
dispensing apparatuses, arranged above the at least one conveying means, for dispensing a washing liquid onto the flakes while the flakes are being mixed.

2. The plant system according to claim 1, wherein the washer comprises at least two consecutive washing stages, comprising recirculation circuits for the washing liquid used in each washing stage and the recirculation circuits are connected by means of at least one cascading line such that the washing stages, cascading in an opposite direction to a direction of transport of the flakes, supply one another with the washing liquid in the opposite direction to a material flow of the flakes.

3. The plant system according to claim 2, wherein a throughput of the washing liquid through each of the dispensing apparatuses per washing stage is 50 to 150 m³/h and/or 10 to 50 l/kg of flakes.

4. The plant system according to claim 2, wherein the dispensing apparatuses are further designed for dispensing external process water and/or fresh water in a last washing stage when viewed in the direction of transport of the flakes.

5. The plant system according to claim 1, wherein the at least one conveying means comprises a motor-driven shaft that extends horizontally through the trough and comprises conveying tools arranged thereon for transporting the flakes along the motor-driven shaft and for mixing the flakes at least in a direction of rotation of the motor-driven shaft.

6. The plant system according to claim 5, wherein the washer comprises at least two consecutive washing stages connected in series, through which the motor-driven shaft extends to a dispensing region for dispensing the wet-cleaned flakes from the washer.

7. The plant system according to claim 2, further comprising a supply line for supplying the at least one cutting mill with washing liquid collected in the washer, wherein the supply line branches off from a storage tank which is integrated into a recirculation circuit of an inlet-side washing stage and is supplied with the washing liquid via at least one processing stage for solid-liquid separation.

8. The plant system according to claim 1, wherein power required by the washer on its own is 10-30 kW and for additional drives for supplying the cutting mill is 8-35 kW and/or a specific electricity consumption of the washer on its own is 0.003-0.015 kWh/kg of input material and for additional drives for supplying the cutting mill is 0.008-0.025 kWh/kg of starting material.

9. The plant system according to claim 1, further comprising a washing module that is downstream of the washer and is designed at least for hot washing, wherein a total electrical power converted for recycling the containers and packaging components in the at least one cutting mill, in the washer and in the washing module is 300-400 kW, a specific energy is 0.1-0.15 kWh per kg of starting material, an associated heating power is 315-465 kW, and/or a heat requirement is 0.11-0.16 kWh per kg of starting material.

10. A method for recycling at least one of used containers and used packaging components, each made of plastic, in a plant system, the method comprising:
wet-shredding the containers or packaging components into flakes in a cutting mill; and
subsequently washing the flakes by transporting the flakes through a trough of a washer and mixing the flakes, and by dispensing a washing liquid including water onto the flakes as the flakes are mixed.

11. The method according to claim 10, further comprising passing the flakes through at least two consecutive washing stages, comprising recirculation circuits for the washing liquid used in each washing stage, wherein a dirt load of the washing liquid decreases from washing stage to washing stage.

12. The method according to claim 11, wherein at least two of the washing stages supply one another at least partially with the washing liquid counter to a material flow of the flakes, and a last washing stage, viewed in a direction of transport of the flakes, is supplied with process water and/or fresh water generated externally.

13. The method according to claim 10, wherein a mean dwell time of the flakes in the trough is 5 to 15 minutes.

14. The method according to claim 10, wherein a material yield of the flakes after being washed in the trough is 97 to 99.5% in relation to an amount of material from the containers and/or packaging components supplied to the cutting mill.

15. The method according to claim 10, wherein the containers comprise beverage bottles with a wall thickness of 200 µm to 3 mm and the packaging components comprise trays with a wall thickness of 100 to 500 µm.

16. The plant system according to claim 5, wherein a rotational speed of the motor-driven shaft is 5 to 30 revolutions per minute.

17. The plant system according to claim 7, wherein the at least one processing stage for solid-liquid separation includes at least one of a hydrocyclone or a screening machine.

18. The plant system according to claim 9, wherein the washing module is designed for rinsing and drying the flakes.

19. The method according to claim 12, wherein the last washing stage is supplied with process water and/or fresh water generated in an associated main washer and/or post-washer.

20. The method according to claim 15, wherein the beverage bottles and the trays are made of PET, PP, and/or PS.
